(19) United States
(12) Patent Application Publication
(10) Pub. No.: US 2012/0085196 A1
(43) Pub. Date: Apr. 12, 2012

(54) ACCELERATOR APPARATUS FOR VEHICLE

(75) Inventor: Hidekazu WATANABE, Aichi-gun (JP)

(73) Assignee: DENSO CORPORATION, Kariya-city (JP)

(21) Appl. No.: 13/227,752

(22) Filed: Sep. 8, 2011

(30) Foreign Application Priority Data
Oct. 12, 2010 (JP) 2010-229601

(51) Int. Cl. G05G 1/30

(52) U.S. Cl. 74/513

(57) ABSTRACT

A friction plate is slidably clamped between a base and a rotor and is enabled to make relative slide movement relative to the base within a predetermined range. The rotor and the friction plate form a first contact arrangement, at which the rotor and the friction plate contact with each other. The base and the friction plate form a second contact arrangement, at which the base and the friction plate contact with each other. A friction coefficient of the first contact arrangement is larger than a friction coefficient of the second contact arrangement.

### CROSS REFERENCE TO RELATED APPLICATION

This application is based on and incorporates herein by reference Japanese Patent Application No. 2010-229601 filed on Oct. 12, 2010.

### BACKGROUND OF THE INVENTION

1. Field of the Invention

The present invention relates to an accelerator apparatus for a vehicle.

2. Description of Related Art

A known accelerator apparatus controls an acceleration state of a vehicle according to the amount of depression of a pedal member, which is depressed by a foot of a driver of the vehicle. One such accelerator apparatus has a pedal force hysteresis mechanism, in which a required pedal force differs between the time of increasing the amount of depression of the pedal member and the time of reducing the amount of depression of the pedal member. For example, in Japanese Unexamined Patent Publication No. 2010-158992A, slant surfaces are formed in a pedal rotor, and slant surfaces are formed in a return rotor. The pedal rotor and the return rotor are coupled with each other through the slant surfaces, so that there is generated a thrust force, which is exerted in a direction of separating the pedal rotor and the return rotor away from each other. Furthermore, a second friction member is placed between the return rotor and the base to increase a frictional force. In this way, a pedal hysteresis mechanism is implemented.

In Japanese Unexamined Patent Publication No. 2010-158992A, a contact radius and a size of a contact surface area between the return rotor and the second friction member are larger than a contact radius and a size of a contact surface area between the base and the second friction member. Therefore, the friction torques of the second friction member are set such that the friction torque of the second friction member at the rotor side thereof is larger than the friction torque of the second friction member at the base side thereof. As a result, at the begging of depressing the pedal, the second friction member is moved synchronously with the return rotor. Thus, overshooting is not generated in a pedal force waveform, so that a slip stroke, which results in a rapid change in a pedal stroke after the overshooting, is limited, and thereby a rapid output change, which is caused by the slip stroke, is also limited.

However, in Japanese Unexamined Patent Publication No. 2010-158992A, due to size variations of the components, such as the second friction member and/or a change in the friction coefficients caused by environmental factors (e.g., temperature and/or humidity), the friction torque of the second friction member at the base side thereof may possibly become larger than the friction torque of the second friction member at the rotor side thereof. When the friction torque of the second friction member at the base side thereof becomes larger than the friction torque of the second friction member at the rotor side thereof, the second friction member and the return rotor do not move synchronously. Therefore, the overshooting occurs in the pedal force waveform to cause the slip stroke and the rapid output change.

### SUMMARY OF THE INVENTION

The present invention addresses the above disadvantages. According to the present invention, there is provided an accelerator apparatus for a vehicle, including a support member, a pedal member, an urging member, a rotor and a friction member. The support member is adapted to be installed to a body of the vehicle. The pedal member is rotatably supported by the support member and has a pad, which is located at one end portion of the pedal member and is adapted to be depressed by a foot of a driver of the vehicle in a depressing direction. The urging member urges the pedal member in an opposite direction, which is opposite from the depressing direction. The rotor is located at the other end portion of the pedal member, which is opposite from the one end portion of the pedal member. The rotor is adapted to be rotated together with the pedal member. The friction member is slidably clamped between the support member and the rotor and is enabled to make relative slide movement relative to the support member within a predetermined range. The rotor and the friction member form a first contact arrangement, at which the rotor and the friction member contact with each other. The support member and the friction member form a second contact arrangement, at which the support member and the friction member contact with each other. A friction coefficient of the first contact arrangement is larger than a friction coefficient of the second contact arrangement.

### BRIEF DESCRIPTION OF THE DRAWINGS

The invention, together with additional objectives, features and advantages thereof, will be best understood from the following description, the appended claims and the accompanying drawings in which:

FIG. 1 is a side view of an accelerator apparatus according to an embodiment of the present invention;

FIG. 2 is a cross sectional view taken along line II-II in FIG. 1;

FIG. 3 is a side view of a rotor of the pedal apparatus of the embodiment;

FIG. 4 is a view taken in a direction of an arrow IV in FIG. 1;

FIG. 5 is a schematic fragmented view for describing pedal slant plate portions and rotor slant plate portions of the embodiment;

FIG. 6 is an enlarged partial view of a portion of FIG. 5 indicated by VI in FIG. 5;

FIG. 7 is a side view of a friction plate of the pedal apparatus of the embodiment;

FIG. 8 is a view taken in a direction of an arrow VIII in FIG. 7;

FIG. 9 is a view taken in a direction IX in FIG. 7;

FIG. 10 is a schematic diagram for describing a relationship between a holding pin and a limiting pin of the friction plate and a holding hole and a limiting hole of a base;

FIG. 11 is an enlarged partial view of a portion of FIG. 2 indicated by XI in FIG. 2;

FIG. 12 is a diagram showing a relationship between a surface roughness of a first contact surface of a rotor and a friction coefficient according to the embodiment;

FIG. 13 is a diagram showing a relationship between a pedal stroke and a pedal force in the embodiment; and

FIG. 14 is a diagram showing a relationship between a pedal stroke and a pedal force in a comparative example.

### DETAILED DESCRIPTION OF THE INVENTION

An accelerator apparatus according to an embodiment of the present invention will be described with reference to the accompanying drawings.

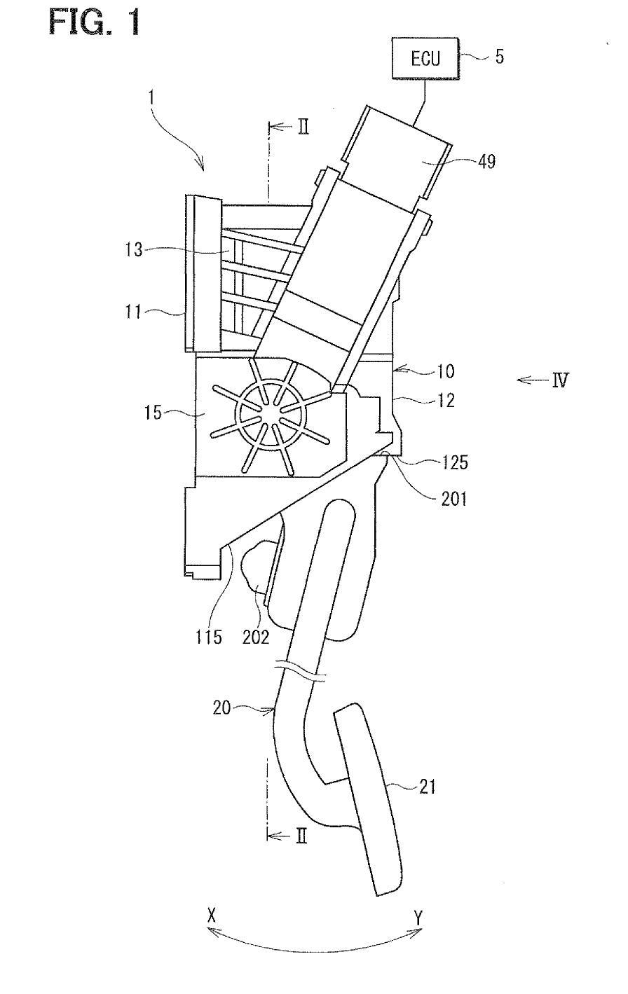

As shown in FIGS. 1, 2 and 4, the accelerator apparatus 1 includes a base (serving as a support member) 10, a pedal member 20, a rotor 30, a double coil spring (serving as an urging member) 39 and a friction plate (serving as a friction member) 50. The accelerator apparatus 1 is installed in a vehicle (e.g., an automobile) and controls an acceleration state of the vehicle based on the amount of depression of the pedal member 20, which is depressed by a foot of a driver of the vehicle. The accelerator apparatus 1 of the present embodiment is a drive-by-wire type, and thereby the pedal member 20 is not mechanically connected to a throttle apparatus of the vehicle. The accelerator apparatus 1 outputs information (electric signal) of a rotational position of the pedal member 20 to an electronic control unit (ECU) 5 of the vehicle, and the ECU 5 controls the throttle apparatus 1 based on the information of the rotational position received from the accelerator apparatus 1. Thereby, the acceleration state of the vehicle is controlled.

The base 10 includes a bottom plate 11, a top plate 12 and two side plates 13, 14. The bottom plate 11 and the top plate 12 are arranged generally parallel to each other. The side plate 13 and the side plate 14 are arranged generally parallel to each other, and the bottom plate 11 and the top plate 12 are connected together by the side plates 13, 14. Therefore, the base 10 is configured into a box form. In the present embodiment, the bottom plate 11, the top plate 12 and the side plates 13, 14 are integrally formed from a resin material.

The bottom plate 11 has a plurality of bolt holes 111, which are fixed to a body of the vehicle with fasteners, such as bolts. A bearing hole 135 is formed in the side plate 13, which is located on a side where a rotational angle sensor 40 described later is installed. A bearing hole 145 is formed in the other side plate 14. The bearing hole 135 and the bearing hole 145 are generally coaxial to each other. A circular holding hole 141 is formed in the side plate 14 at a location radially outward of the bearing hole 145. A limiting hole 142, which is configured into a sector shape, is formed in the side plate 14 at a location, which is radially outward of the bearing hole 145 on an opposite side of the bearing hole 145, which is diametrically opposite from the holding hole 141.

The cover 15 is configured into a generally U-shape in a view taken from a top side of FIG. 1. The cover 15 is installed to the base 10 from a side (left side in FIG. 1) where the bottom plate 11 is located such that the cover 15 clamps the side plates 13, 14 and forms a housing in corporation with the base 10.

The pedal member 20 is made of, for example, a resin material and is configured into an elongated body. The pedal member 20 includes a pad 21 at one end portion thereof and a rotatable shaft portion 22 at the other end portion thereof. The pedal member 20 is rotatably placed between a stopper 125 of the top plate 12 and a stopper 115 of the bottom plate 11. Specifically, when the pedal member 20 is not depressed by the driver, a stopper surface 201 of the pedal member 20 contacts the stopper 125 of the top plate 12. When the pedal member 2 is depressed by the foot of the driver, the pedal member 20 can be rotated until a kick-down switch 202 of the pedal member 20 contacts the stopper 115 of the bottom plate 11.

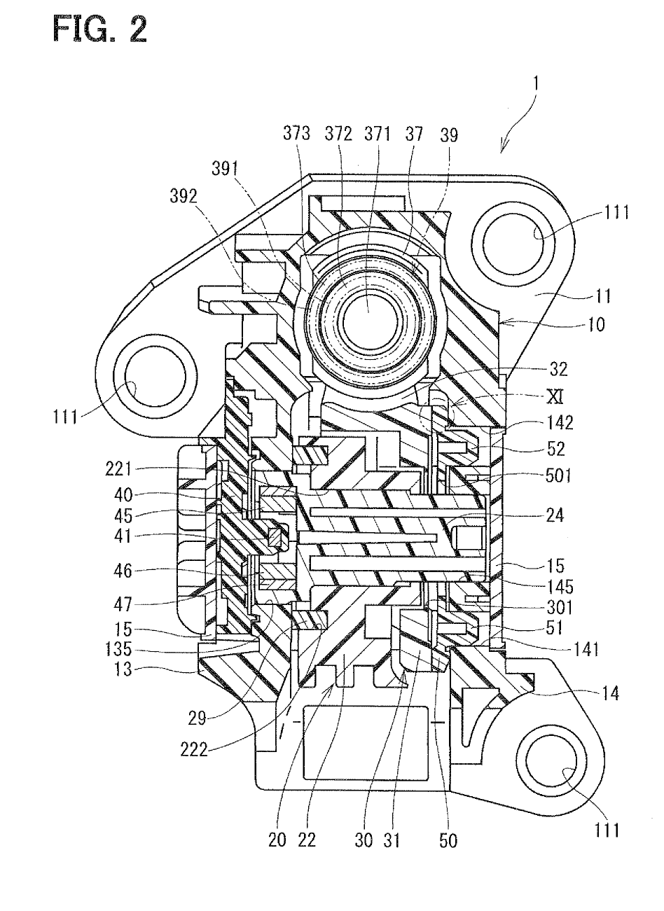

As shown in FIG. 2, a hole 221 is formed in the rotatable shaft portion 22, and a shaft member 24 is received through the hole 221. The rotatable shaft portion 22 has a projection (not shown), which radially inwardly projects into the hole 221 and is fitted into a groove (not shown) that is formed in the shaft member 24. In this way, the rotatable shaft portion 22 and the shaft member 24 are rotated integrally. One end portion of the shaft member 24 is rotatably supported in the bearing hole 135 of the side plate 13, and the other end portion of the shaft member 24 is rotatably supported in the bearing hole 145 of the side plate 14. In this way, the pedal member 20 is rotatable integrally with the shaft member 24 about a central axis of the shaft member 24. Thereby, the pedal member 20 is rotatably supported by the base 10.

A friction ring 29 is placed between the rotatable shaft portion 22 and the side plate 13 of the base 10. The friction ring 29 is configured into a cylindrical tubular body and is fixed to an annular groove 222, which is formed in a side plate 13 side end surface of the rotatable shaft portion 22. A side plate 13 side end surface of the friction ring 29 contacts the side plate 13. Thereby, when the friction ring 29 is rotated in response to rotation of the rotatable shaft portion 22 of the pedal member 20, the friction ring 29 slides on the side plate 13 and thereby generates a friction torque. The friction torque, which is generated upon the sliding of the friction ring 29 on the side plate 13, is generated through an entire rotatable range of the pedal member 20.

A rotor 30 is provided at an opposite end portion of the pedal member 20, which is opposite from the pad 21, i.e., is provided at the rotatable shaft portion 22 side of the pedal member 20. The rotor 30 is made of, for example, a resin material and includes an annular portion 31 and a projecting portion 32. The annular portion 31 is configured to have a generally annular form. The projecting portion 32 radially outwardly projects from the annular portion 31 in an opposite direction, which is opposite from the pad 21 of the pedal member 20. The annular portion 31 is generally coaxial with the rotatable shaft portion 22, and the shaft member 24 is received through a hole 301, which is formed generally in a center of the annular portion 31.

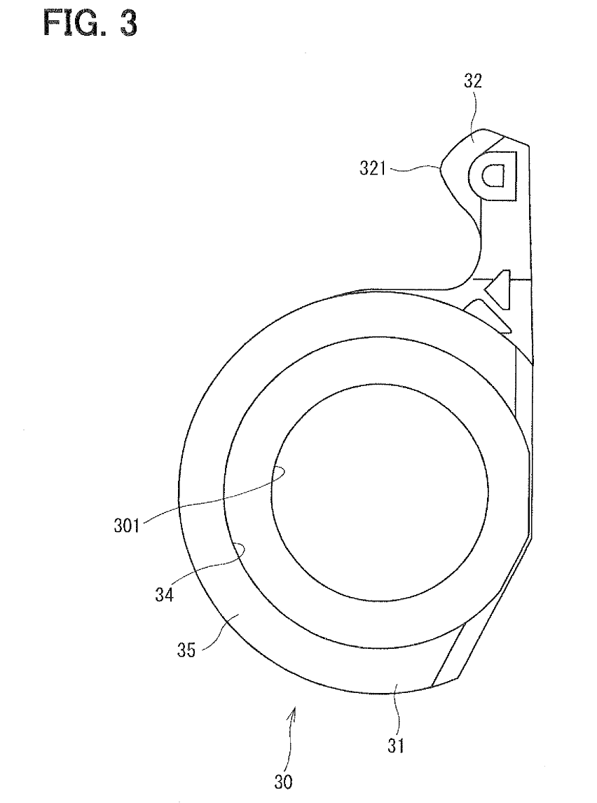

Now, the rotor 30 will be described with reference to FIG. 3. FIG. 3 is a side view of the rotor 30 seen from the side plate 14 side of the rotor 30. As shown in FIG. 3, a step 34 is formed in the side plate 14 side surface of the rotor 30. The rotor 30 includes a first contact surface (or simply referred to as a contact surface) 35, which contacts the friction plate 50 and is located radially outward of the step 34. The first contact surface 35 is processed through a surface roughening process. The surface roughening process of the present embodiment is a surface texturing process (also referred to as a graining process). The first contact surface 35 serves as a contact surface of the rotor 30, which contacts the friction plate (friction member) 50.

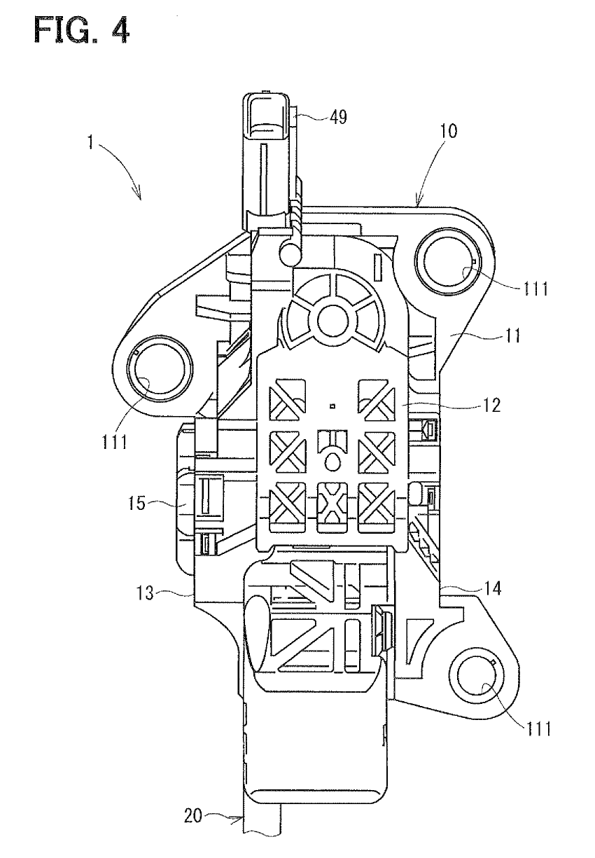

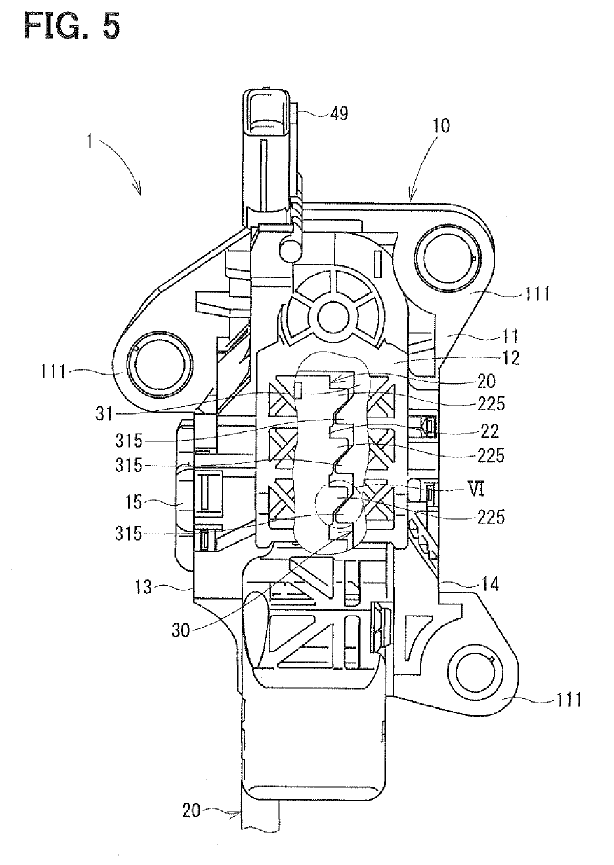

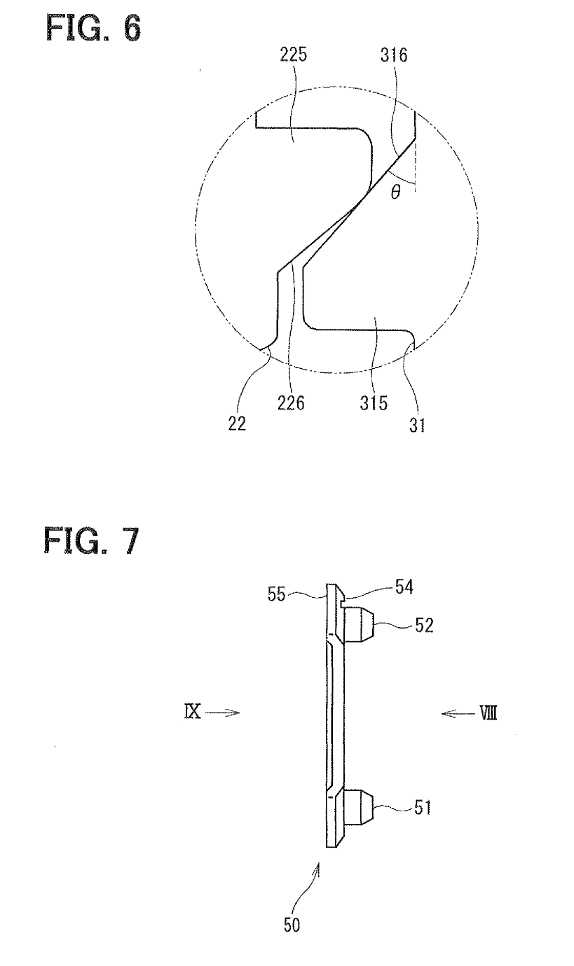

Now, a relationship between the pedal member 20 and the rotor 30 will be described with reference to FIGS. 5 and 6. FIG. 5 corresponds to FIG. 4 and is a partially fractured view of FIG. 4. FIG. 6 is a partial enlarged view showing a portion of FIG. 5, which is indicated by VI in FIG. 5. As shown in FIGS. 5 and 6, a plurality of pedal slant plate portions (or simply referred to as pedal slant portions) 225 is formed in the rotatable shaft portion 22 of the pedal member 20 and projects toward the annular portion 31 of the rotor 30. The pedal slant plate portions 225 are arranged one after another in a circumferential direction in an opposed surface of the rotatable shaft portion 22, which is opposed to the annular portion 31 of the rotor 30. Each pedal slant plate portion 225 includes a pedal slant surface 226. Furthermore, a plurality of rotor slant plate portions (or simply referred to as rotor slant portions) 315 is formed in the annular portion 31 of the rotor 30 and projects toward the rotatable shaft portion 22 of the pedal member 20. The rotor slant plate portions 315 are arranged one after another in a circumferential direction in an opposed surface of the annular portion 31 of the rotor 30, which is opposed to the rotatable shaft portion 22 of the pedal member 20. Each rotor slant plate portion 315 has a rotor slant surface 316, which is engageable with a corresponding one of the pedal slant surfaces 226. As discussed above, the pedal slant plate portions 225 are arranged one after another in the circumferential direction of the rotatable shaft portion 22, and the rotor slant plate portions 315 are arranged one after another in the circumferential direction of the annular portion 31. In FIG. 5, the pedal slant plate portions 225 and the rotor slant plate portions 315 are drawn in planar form (i.e., two dimensionally) for the descriptive purpose.

A curved convex surface 321 is formed at the projecting portion 32 (see FIGS. 2 and 3) of the rotor 30 on the top plate 12 side (see FIG. 3), and a holder 37 (see FIG. 2) is placed on the curved convex surface 321 in a manner that enables relative movement therebetween. The holder 37 has a curved concave surface, which contacts the curved convex surface 321. A radius of curvature of the curved concave surface of the holder 37 is larger than a radius of curvature of the curved convex surface 321 of the projecting portion 32.

A spherical projection 371, which projects toward the top plate 12 side, is formed in a center of the holder 37. An inner engaging surface 372 and an outer engaging surface 373 are formed on a radially outer side of the spherical projection 371.

The double coil spring 39, which is placed between the holder 37 and the top plate 12, includes inner and outer coil springs 391, 392, which are compression coil springs. One end part of the inner coil spring 391 is engaged with the top plate 12, and the other end part of the inner coil spring 391 is engaged with the inner engaging surface 372 of the holder 37. One end part of the outer coil spring 392 is engaged with the top plate 12, and the other end part of the outer coil spring 392 is engaged with the outer engaging surface 373 of the holder 37.

The double coil spring 39 urges the rotor 30 and the pedal member 20 in a direction (releasing direction) Y in FIG. 1 through the holder 37. In the present embodiment, the holder 37 is placed on the curved convex surface 321 of the projecting portion 32 of the rotor 30 in the manner that enables the relative movement therebetween. Therefore, when the rotor 30 makes arcuate movement due to the depressing force of the driver applied to the pedal member 20 and the urging force of the double coil spring 39, the double coil spring 39 can linearly expand and contract.

The rotational angle sensor 40 is provided to the side plate 13 side of the base 10. The rotational angle sensor 40 includes a sensor element 41. The sensor element 41 may be, for example, a Hall element or a magnetoresistive element and is placed at a location, which is adjacent to a side plate 13 side end portion of the shaft member 24. Two magnets 45, 46 and a magnetic path member 47 are fixed to the side plate 13 side end portion of the shaft member 24. When the pedal member 20 is rotated, the shaft member 24 and the magnets 45, 46 are also rotated. Thereby, the magnetic field changes at a location around the side plate 13 side end portion of the shaft member 24. The sensor element 41 of the rotational angle sensor 40 senses this change in the magnetic field and outputs a measurement signal, which corresponds to the rotational angle of the pedal member 20. This measurement signal is outputted to the ECU 5 through a connector 49. In this way, the ECU 5 can sense the rotational position of the pedal member 20.

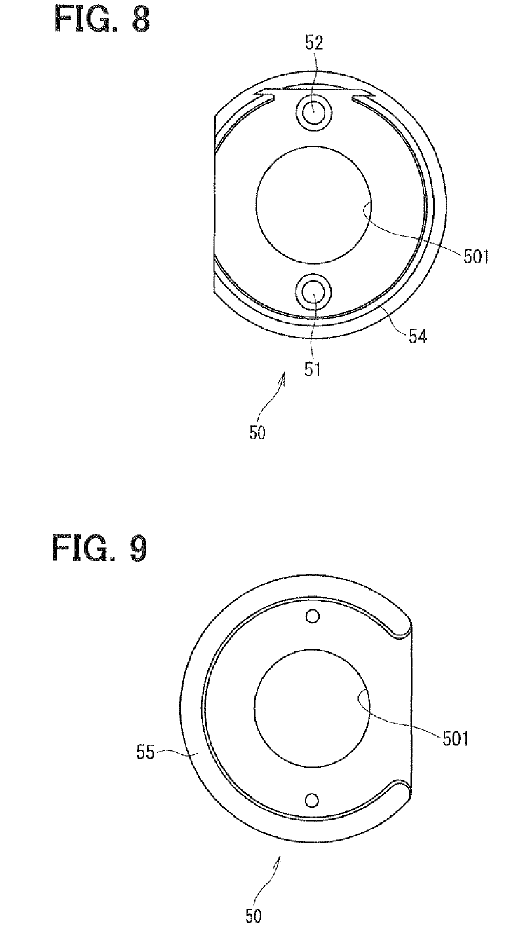

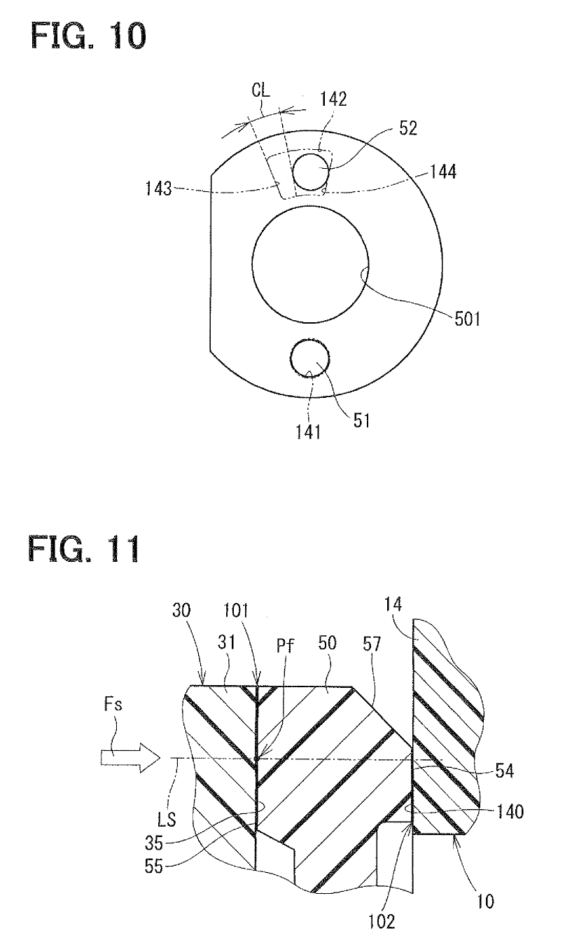

A friction plate 50 is placed between the rotor 30 and the side plate 14 of the base 10. FIGS. 7 to 11 show the friction plate 50. Specifically, FIG. 7 is a side view of the friction plate 50 of FIG. 2 seen from a front side of the plane of FIG. 2. FIG. 8 is a view taken in a direction of an arrow XIII in FIG. 7. FIG. 9 is a view taken in a direction of an arrow IX in FIG. 7. FIG. 10 is a schematic view of the friction plate 50 shown in FIG. 8 for describing a relationship between a holding hole 141 and a limiting hole 142 of the base 10 and the friction plate 50. In FIG. 10, the holding hole 141 and the limiting hole 142 are indicated by a dot-dot-dash line. FIG. 11 is a schematic view for describing a contact between the base 10 and the friction plate 50 and a contact between the rotor 30 and the friction plate 50, showing a portion of FIG. 2, which is indicated by XI in FIG. 2.

The friction plate 50 is made of, for example, a resin material and is configured into a generally annular form. The shaft member 24 is received through a hole 501, which is formed at a center of the friction plate 50. The friction plate 50 is slidably clamped between the rotor 30 and the side plate 14. The friction plate 50 includes a holding pin 51 and a limiting pin 52, which project toward the side plate 14. The holding pin 51 and the limiting pin 52 are symmetrically arranged about the shaft member 24.

The holding pin 51 is inserted into and is rotatably held in the holding hole 141, which is formed in the side plate 14. When the holding pin 51 is inserted into the holding hole 141, the friction plate 50 is temporarily fixed to the side plate 14. In this way, the assembling work is eased.

The limiting pin 52 is inserted into the limiting hole 142, which is formed in the side plate 14. As shown in FIG. 10, the limiting hole 142 is configured into the sector shape, and a predetermined clearance CL is circumferentially formed between an inner wall 143 of the limiting hole 142 and the limiting pin 52. The relative slide movement between the friction plate 50 and the side plate 14 is possible only within the range of the clearance CL. Specifically, in the present embodiment, the relative slide movement between the friction plate 50 and the side plate 14 is enabled within an angular range, which is up to contacting of the limiting pin 52 to the inner wall 143 of the limiting hole 142 at the begging of depressing the pedal member 20 in the depressing direction (direction X in FIG. 1), and also within an angular range, which is up to contacting of the limiting pin 52 to an opposite inner wall 144 of the limiting hole 142 at the time of releasing the pedal member 20 in the releasing direction (direction Y in FIG. 1), which is opposite from the depressing direction (direction X in FIG. 1). The slide movement between the friction plate 50 and the rotor 30 is possible through all of the angular range except the angular range, in which the slide movement between the friction plate 50 and the side plate 14 is made. The slidable angular range, in which the relative slide movement between the friction plate 50 and the side plate 14 is possible, is set to be sufficiently smaller than the slidable range, in which the relative slide movement between the friction plate 50 and the rotor 30 is possible.

The friction plate 50 includes a base side slide surface 54 at the side plate 14 side of the friction plate 50. The friction plate 50 further includes a rotor side slide surface 55 at the rotor 30 side of the friction plate 50. The base side slide surface 54 of the friction plate 50 contacts a second contact surface 140 of the side plate 14. The rotor side slide surface 55 of the friction plate 50 contacts the first contact surface 35 of the rotor 30. In the present embodiment, the first contact surface 35 and the rotor side slide surface 55 form a first contact arrangement 101, and the second contact surface 140 and the base side slide surface 54 form a second contact arrangement 102. As discussed above, the surface texturing process is applied to the first contact surface 35 of the rotor 30. However, the surface roughening process (including the surface texturing process) is not applied to the second contact surface 140 of the side plate 14. Therefore, a friction coefficient μr of the first contact arrangement 101, i.e., the friction coefficient μr between the first contact surface 35 of the rotor 30 and the rotor side slide surface 55 of the friction plate 50 is larger than a friction coefficient μb of the second contact arrangement 102, i.e., the friction coefficient μb between the second contact surface 140 of the side plate 14 and the base side slide surface 54 of the friction plate 50. Furthermore, in a case where the material of the rotor 30 is different from the material of the base 10, the environmental characteristics of the friction coefficient μr and the friction coefficient μb may vary due to environmental factors, such as the temperature and/or humidity. In the present embodiment, the friction coefficient μr of the first contact arrangement 101 and the friction coefficient μb of the second contact arrangement 102 are set in view of the environmental characteristics such that the relationship of μr>μb does not change even when the environmental factors (e.g., the temperature and/or humidity) are changed.

The friction plate 50 includes a slant surface 57, which is located on the side plate 14 side of the friction plate 50 and is slanted, i.e., inclined radially inward. Thereby, a contact radius (a radial size of a contact area) between the friction plate 50 and the rotor 30 is larger than a contact radius (a radial size of a contact area) between the friction plate 50 and the side plate 14. Furthermore, a size of a surface area of the rotor side slide surface 55 is larger than a size of a surface area of the base side slide surface 54. Thereby, a size of a contact surface area Sr of the first contact arrangement 101, in which the friction plate 50 and the rotor 30 contact with each other, is larger than a size of a contact surface area Sb of the second contact arrangement 102, in which the friction plate 50 and the side plate 14 contact with each other.

Now, the operation of the accelerator apparatus 1 will be described.

When the pedal member 20 is not depressed by the foot of the driver, the pedal member 20 is urged by the double coil spring 39 in the direction Y in FIG. 1, so that the stopper surface 201 contacts the stopper 125 of the top plate 12.

When the pedal member 20 is depressed by the foot of the driver, the pedal member 20 is rotated in the direction X in FIG. 1. When the rotatable shaft portion 22 of the pedal member 20 is rotated, each of the pedal slant plate portions 225 and the corresponding one of the rotor slant plate portions 315 are engaged with each other such that the pedal slant surfaces 226 of the pedal slant plate portions 225 are contacted with and are engaged with the rotor slant surfaces 316, respectively, of the rotor slant plate portions 315. Thereby, the pedal member 20 is rotated together with the rotor 30. When the pedal member 20 is rotated in the direction X upon the application of the pedal force from the foot of the driver onto the pedal member 20, the double coil spring 39 is compressed. When the double coil spring 39 is compressed, the urging force, which urges the pedal member 20 in the direction Y, is increased. Therefore, when the amount of rotation of the pedal member 20 is increased, the pedal force, which is required to rotate the pedal member 20 in the direction X, is increased.

Furthermore, when the pedal member 20 and the rotor 30 are rotated together upon the engagement of the pedal slant surfaces 226 to the rotor slant surfaces 316, respectively, a load (hereinafter referred to as a thrust force Fs), which pulls the pedal member 20 and the rotor 30 away from each other, is generated by the pedal force of the driver and the urging force of the double coil spring 39. Due to the generation of the thrust force Fs, a frictional force is generated between the friction ring 29, which is provided to the rotatable shaft portion 22 of the pedal member 20, and the side plate 13, and a frictional force is generated between the annular portion 31 of the rotor 30 and the friction plate 50. When the thrust force Fs is increased, the frictional force, which is generated between the friction ring 29 and the side plate 13, and the frictional force, which is generated between the annular portion 31 of the rotor 30 and the friction plate 50, are increased. Furthermore, as discussed above, when the amount of rotation of the pedal member 20 in the direction X is increased, the pedal force of the driver and the urging force of the double coil spring 39 are increased. Thereby, in response to the increase in the amount of rotation of the pedal member 20 in the direction X, the thrust force Fs is increased. That is, when the amount of rotation of the pedal member 20 is increased, the frictional force between the friction ring 29 and the side plate 13 and the frictional force between the annular portion 31 of the rotor 30 and the friction plate 50 are increased. These frictional forces interfere with the rotational movement of the pedal member 20, and thereby the required pedal force, which is required to rotate the pedal member 20, is increased. The pedal member 20 can be rotated in the direction X until the kick-down switch 202 contacts the stopper 115 of the bottom plate 11.

As shown in FIG. 11, the friction plate 50 is configured such that a load center line LS, which extends through a load point Pf and indicates an applied direction of the thrust force Fs, is located within the extent of the second contact arrangement 102, so that a load center of the thrust force Fs, which is applied from the rotor 30 to the side plate 14 of the base 10, is located within the extent of the second contact arrangement 102 (i.e., within the extent of the base side slide surface 54 of the friction plate 50). Thereby, a torsional deformation of the friction plate 50 can be limited.

In contrast, when the pedal member 20 is rotated in the direction Y, the frictional force, which is generated between the friction ring 29 and the side plate 13, and the frictional force, which is generated between the annular portion 31 of the rotor 30 and the friction plate 50, interfere with the rotational movement of the pedal member 20 and thereby reduce the required pedal force of the driver.

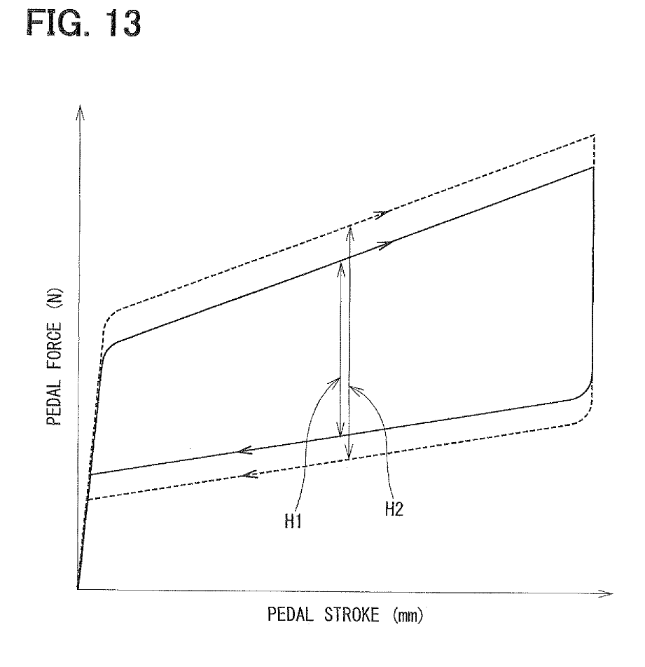

Thus, a difference exists between the required pedal force at the time of rotating the pedal member 20 in the direction X and the required pedal force at the time of rotating the pedal member 20 in the direction Y, and thereby a pedal force hysteresis mechanism is implemented (see FIG. 13). In this way, the driver can experience the improved operational feeling of the pedal member 20.

As discussed above, the frictional force, which is generated between the friction ring 29 and the side plate 13, and the frictional force, which is generated between the annular portion 31 of the rotor 30 and the friction plate 50, contribute to the implementation of the pedal force hysteresis mechanism. However, in the following description, only the frictional force, which is generated between the annular portion 31 of the rotor 30 and the friction plate 50, will be mainly discussed.

Now, the relationship between the pedal stroke and the pedal force will be described.

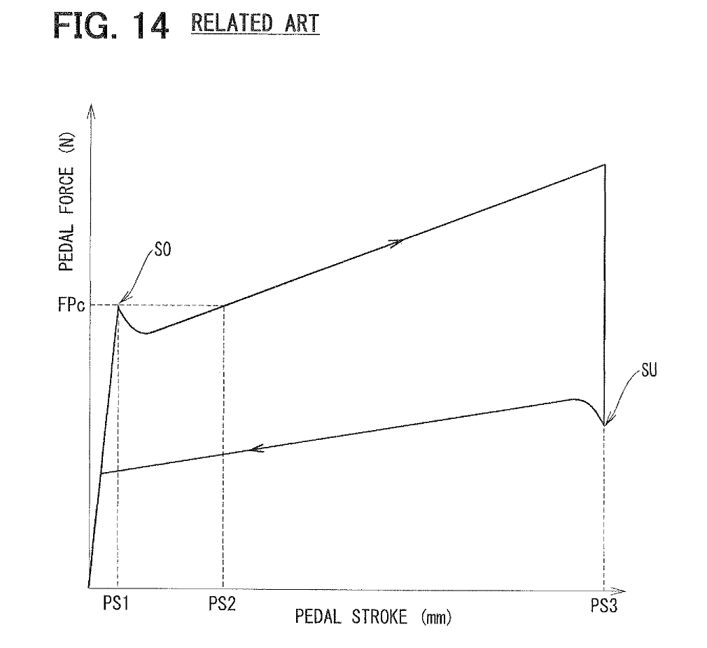

FIG. 14 shows a relationship between a pedal stroke and a pedal force in a comparative example. In the comparative example, the friction plate 50 is fixed to the side plate 14, and thereby there is no relative slide movement between the friction plate 50 and the side plate 14 through the entire angular range. As shown in FIG. 14, when the pedal member 20 is depressed down to a pedal stroke PS1 at the begging of depressing the pedal member 20, slide movement between the rotor 30 and the friction plate 50 starts. When the slide movement between the rotor 30 and the friction plate 50 starts, the frictional force, which is generated between the rotor 30 and the friction plate 50, is changed from a static frictional force to a kinetic frictional force, so that a required pedal force, which is required to rotate the pedal member 20, is reduced. In other words, in a pedal force waveform shown in FIG. 14, as indicated by reference sign SO, when the pedal member 20 is depressed down to the pedal stroke PS1, the pedal force is temporarily increased, the phenomenon of which is known as “overshooting”. Once the overshooting occurs, a slip stroke may occur such that the pedal member 20 is rapidly and suddenly displaced to a pedal stroke PS2, at which the pedal force becomes a pedal force FPc that is a peak pedal force at the time of occurrence of the overshooting. Thereby, the output may possibly be suddenly changed due to the occurrence of the slip stroke. Furthermore, when the output is suddenly changed due to the occurrence of the slip stroke, the driver may possibly feel abrupt starting (abrupt acceleration) of the vehicle.

Similarly, at the time of releasing the pedal member 20 from a pedal stroke PS3, as indicated by a reference sign SU in FIG. 14, the pedal force may be temporarily reduced, the phenomenon of which is known as “undershooting”.

Now, the frictional torques of the friction plate 50 of the present embodiment will be described. The frictional torques of the friction plate 50 are limited by the friction coefficients, the sizes of the contact surface areas and the thrust force Fs (the thrust force Fs being generated by the engagement between the pedal slant plate portions 225 and the rotor slant plate portions 315). In the present embodiment, the same amount of the thrust force Fs is applied to the rotor 30 side and the side plate 14 side. The surface texturing process is applied to the first contact surface 35 of the rotor 30, which contacts the rotor side slide surface 55 of the friction plate 50. In contrast, the surface roughening process, such as the surface texturing process, is not applied to the second contact surface 140, which is the contact surface of the side plate 14 that contacts the base side slide surface 54 of the friction plate 50. Therefore, the friction coefficient μr of the first contact arrangement 101, which is formed by the first contact surface 35 and the rotor side slide surface 55, is larger than the friction coefficient μb of the second contact arrangement 102, which is formed by the second contact surface 140 and the base side slide surface 54. Furthermore, as discussed above, the contact surface area Sr of the first contact arrangement 101, in which the friction plate 50 and the rotor 30 contact with each other, is larger than the contact surface area Sb of the second contact arrangement 102, in which the friction plate 50 and the side plate 14 contact with each other. Therefore, a rotor 30 side friction torque Tr of the friction plate 50 is larger than a side plate 14 side friction torque Tb of the friction plate 50.

When the pedal force is applied from the foot of the driver to the pedal member 20, the pedal member 20 and the rotor 30 are integrally rotated due to the engagement between the pedal slant plate portions 225 and the rotor slant plate portions 315.

Furthermore, the thrust force Fs, which is the urging force applied from the rotor 30 side to the side plate 14 side, is applied to the load point Pf. At this time, as discussed above, the rotor 30 side friction torque Tr of the friction plate 50 is larger than the side plate 14 side friction torque Tb of the friction plate 50. Therefore, the slide movement occurs between the friction plate 50 and the side plate 14 to cause the synchronous movement of the friction plate 50 with the rotor 30 within the angular range, which is up to the contacting of the limiting pin 52 to the inner wall 143 of the limiting hole 142, i.e., within the angular range of the clearance CL. Furthermore, once the limiting pin 52 is circumferentially moved to the point where the limiting pin 52 contacts the inner wall 143 of the limiting hole 142, the relative slide movement no longer occurs between the friction plate 50 and the side plate 14, and the relative slide movement begins to occur between the friction plate 50 and the rotor 30.

At the time of releasing the pedal member 20 in the releasing direction (direction Y in FIG. 1), similarly, the rotor 30 side friction torque Tr of the friction plate 50 is larger than the side plate 14 side friction torque Tb, so that the relative slide movement occurs between the friction plate 50 and the side plate 14 to cause the synchronous movement of the friction plate 50 with the rotor 30 within the angular range, which is up to the contacting of the limiting pin 52 to the inner wall 144 of the limiting hole 142, i.e., within the angular range of the clearance CL. Furthermore, once the limiting pin 52 is circumferentially moved to the point where the limiting pin 52 contacts the inner wall 144 of the limiting hole 142, the relative slide movement no longer occurs between the friction plate 50 and the side plate 14, and the relative slide movement begins to occur between the friction plate 50 and the rotor 30.

Thereby, as shown in FIG. 13, the pedal force waveform becomes blunt (smoother) at the beginning of the depressing the pedal member 20 and also at the time of releasing the pedal member 20, so that the overshooting and the undershooting do not occur. As a result, it is possible to limit the slip stroke and the rapid change in the output caused by the slip stroke. Furthermore, it is possible to limit the driver's feeling of abrupt starting (abrupt acceleration) of the vehicle. Also, the frictional force, which corresponds to the pedal stroke, is generated between the rotor 30 and the friction plate 50, and there is implemented the pedal force hysteresis mechanism, which does not substantially generate the overshooting and the undershooting in the pedal force waveform.

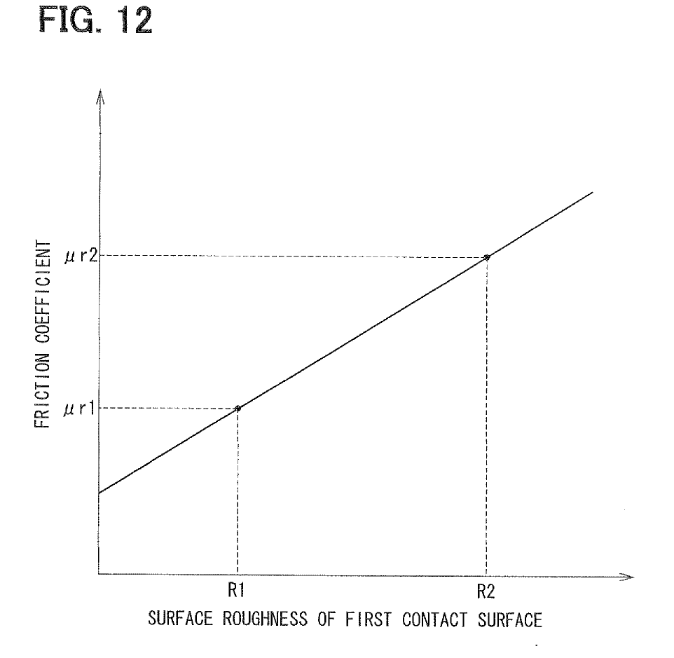

In the present embodiment, the surface texturing process is applied to the first contact surface 35 of the rotor 30 to increase the friction coefficient μr of the first contact arrangement 101. As shown in FIG. 12, when the contact surface roughness, which is the surface roughness of the first contact surface 35, is increased, the friction coefficient μr is increased. Specifically, the friction coefficient μr2 at the contact surface roughness of R2 is larger than the friction coefficient μr1 at the contact surface roughness of R1. When the friction coefficient μr of the first contact arrangement 101 is increased, the pedal force hysteresis, which is the difference between the required pedal force at the time of depressing the pedal member 20 and the required pedal force at the time of releasing the pedal member 20 is increased. In FIG. 13, a pedal force waveform, which is obtained at the contact surface roughness of R1, is indicated by a solid line, and a pedal force waveform, which is obtained at the contact surface roughness of R2, is indicated by a dotted line. As shown in FIG. 13, in the case where the structure of the pedal apparatus other than the surface roughness of the first contact surface 35 is made the same, the pedal force hysteresis H2 at the contact surface roughness of R2 is larger than the pedal force hysteresis H1 at the contact surface roughness R1.

Furthermore, the pedal force hysteresis is increased when the thrust force Fs is increased. As in the present embodiment, in the case where it is desirable to increase the friction coefficient μr and to reduce the pedal force hysteresis, the thrust force Fs, which is applied from the rotor 30 side to the friction plate 50 side, may be reduced. Now, it is assumed that the slant angle of the rotor slant surface 316 shown in FIG. 6 is θ, and the thrust force Fs is proportional to 1/tan θ. Therefore, when the thrust force Fs needs to be reduced, the slant angle θ of the rotor slant surface 316 should be increased. As discussed above, when the slant angle θ of the rotor slant surface 316 and the friction coefficient μr are appropriately set, the desired pedal force hysteresis can be achieved.

As discussed above, the accelerator apparatus 1 includes the base 10 adapted to be installed to the vehicle body, the pedal member 20, the double coil spring 39, the rotor 30 and the friction plate 50. The pedal member 20 is rotatably supported by the base 10 and has the pad 21 at the one end portion of the pedal member 20 to allow the driver to depress the pedal member 20 with his/her foot. The double coil spring 39 urges the pedal member 20 in the opposite direction (releasing direction), which is opposite from the depressing direction. The rotor 30 is provided to the other end portion of the pedal member 20, which is opposite from the pad 21. The rotor 30 is rotatable together with the pedal member 20. The friction plate 50 is slidably clamped between the base 10 and the rotor 30, and relative slide movement between the friction plate 50 and the base 10 is enabled within the predetermined range. In the present embodiment, the friction plate 50 includes the limiting pin 52, which is received in the limiting hole 142 of the base 10 such that the predetermined clearance CL is circumferentially provided between the inner wall of the limiting hole 142 and the limiting pin 52. The slide movement between the base 10 and the friction plate 50 is permitted only within the movable range of the limiting pin 52 in the limiting hole 142.

The friction coefficient μr of the first contact arrangement 101, in which the rotor 30 and the friction plate 50 contact with each other, is larger than the friction coefficient μb of the second contact arrangement 102, in which the side plate 14 of the base 10 and the friction plate 50 contact with each other. Therefore, the friction torques of the friction plate 50 are set such that the friction torque of the friction plate 50 at the rotor 30 side of the friction plate 50 is larger than the friction torque of the friction plate 50 at the base 10 side of the friction plate 50. The friction plate 50 and the rotor 30 are synchronously moved, i.e., are moved together within the angular range, in which the slide movement between the friction plate 50 and the base 10 is permitted. In this way, the overshooting SO is not generated in the pedal force waveform, and it is possible to limit the slip stroke and the abrupt output change caused by the slip stroke. Therefore, the operational feeling of the driver is improved. Furthermore, the undershooting SU is not generated at the time of releasing the pedal member 20, and thereby the operational feeling of the driver is improved.

In the present embodiment, the surface roughening process is applied to the first contact surface 35, which is the contact surface of the rotor 30 that contacts the friction plate 50. Therefore, the friction coefficient μr of the first contact arrangement 101 is larger than the friction coefficient μb of the second contact arrangement 102, to which the surface roughening process is not applied. Furthermore, the surface roughening process of the present embodiment is the surface texturing process. Thereby, the surface roughening process of the first contact surface 35 can be implemented with a die (resin molding processing of the first contact surface 35 with the die). Thus, it is not required to have a separate step for implementing the surface roughening process, and thereby it is possible to limit an increase in the costs.

Furthermore, the size of the rotor side slide surface 55 of the friction plate 50 is larger than the size of the base side slide surface 54 of the friction plate 50. That is, the size of the contact surface area Sr of the first contact arrangement 101, in which the first contact surface 35 of the rotor 30 and the rotor side slide surface 55 of the friction plate 50 contact with each other, is larger than the size of the contact surface area Sb of the second contact arrangement 102, in which the second contact surface 140 of the side plate 14 and the base side slide surface 54 of the friction plate 50 contact with each other. Thereby, the friction torques of the friction plate 50 are set such that the friction torque of the friction plate 50 at the base 10 side thereof is larger than the friction torque of the friction plate 50 at the rotor 30 side thereof, so that the slip stroke and the abrupt output change caused by the slip stroke can be limited.

The opposed surface of the pedal member 20, which is opposed to the rotor 30, has the pedal slant plate portions 225, which have the pedal slant surfaces 226, respectively. Also, the opposed surface of the rotor 30, which is opposed to the pedal member 20, has the rotor slant plate portions 315 that have the rotor slant surfaces 316, respectively, which can be engaged with the pedal slant surfaces 226, respectively. The pedal slant surfaces 226 of the pedal slant plate portions 225 and the rotor slant surfaces 316 of the rotor slant plate portions 315 are engaged with each other. Thereby, the pedal member 20 and the rotor 30 are integrally rotated. When the pedal member 20 and the rotor 30 are integrally rotated, there is generated the thrust force Fs, which is the urging force applied from the rotor 30 side to the friction plate 50 side. This thrust force Fs is proportional to 1/tan θ where θ denotes the slant angle of each rotor slant surface 316. The pedal force hysteresis is defined by the friction coefficient μr between the rotor 30 and the friction plate 50 and the thrust force Fs. Therefore, when the friction coefficient μr of the first contact arrangement 101 and the slant angle θ of the rotor slant surface 316 are adjusted, the desired hysteresis can be implemented.

The load center line LS, which extends through the load point Pf of the thrust force Fs and indicates the applied direction of the thrust force Fs, is located within the extent of the second contact arrangement 102. Thereby, the load point Pf of the thrust force Fs does not float (i.e., the load point Pf being effectively clamped between the rotor 30 side and the base 10 side), so that the torsional deformation of the friction plate 50 can be limited.

Now, modifications of the above embodiment will be described.

In the above embodiment, the surface roughening process of the first contact surface of the rotor is implemented by the surface texturing process. In a modification of the above embodiment, the surface roughening process of the first contact surface of the rotor may be implemented by any other appropriate process, such as shot blasting, which is other than the surface texturing process. Furthermore, the first contact surface of the rotor may be processed through any other appropriate process, which is other than the surface roughening process and increases the friction coefficient of the first contact surface of the rotor. For example, a material, which has a high friction coefficient, may be provided in the first contact surface by coinjection molding or coating. Furthermore, the second contact surface of the side plate may be processed to have a low friction coefficient. For example, a material, which has a low friction coefficient, may be provided in the second contact surface by coinjection molding or coating.

The present invention is not limited the above embodiment and modifications thereof. That is, the above embodiment and modifications thereof may be modified in various ways without departing from the spirit and scope of the invention.

1. An accelerator apparatus for a vehicle, comprising:
a support member that is adapted to be installed to a body of the vehicle;
a pedal member that is rotatably supported by the support member and has a pad, which is located at one end portion of the pedal member and is adapted to be depressed by a foot of a driver of the vehicle in a depressing direction;
an urging member that urges the pedal member in an opposite direction, which is opposite from the depressing direction;
a rotor that is located at the other end portion of the pedal member, which is opposite from the one end portion of the pedal member, wherein the rotor is adapted to be rotated together with the pedal member; and
a friction member that is slidably clamped between the support member and the rotor and is enabled to make relative slide movement relative to the support member within a predetermined range, wherein:
the rotor and the friction member form a first contact arrangement, at which the rotor and the friction member contact with each other;
the support member and the friction member form a second contact arrangement, at which the support member and the friction member contact with each other; and
a friction coefficient of the first contact arrangement is larger than a friction coefficient of the second contact arrangement.

2. The accelerator apparatus according to claim 1, wherein a contact surface of the rotor, which contacts the friction member, is roughed by a surface roughening process.

3. The accelerator apparatus according to claim 2, wherein the surface roughening process is a surface texturing process.

4. The accelerator apparatus according to claim 1, wherein a size of a contact surface area of the first contact arrangement, at which the rotor and the friction member contact with each other, is larger than a size of a contact surface area of the second contact arrangement, at which the support member and the friction member contact with each other.

5. The accelerator apparatus according to claim 1, wherein:
the pedal member includes at least one pedal slant plate portion, which has a pedal slant surface;
the rotor includes at least one rotor slant plate portion, which has a rotor slant surface that is contactable with the pedal slant surface of a corresponding one of the at least one pedal slant plate portion; and
the at least one pedal slant plate portion and the at least one rotor slant plate portion are adapted to engage with each other such that the pedal slant surface of the at least one pedal slant plate portion is contacted with and is engaged with the rotor slant surface of the at least one rotor slant plate portion.

6. The accelerator apparatus according to claim 1, wherein a load center of a thrust force, which is applied from the rotor to the support member, is located within an extent of the second contact arrangement.
